(19) United States
(12) Patent Application Publication
(10) Pub. No.: US 2007/0050258 A1
(43) Pub. Date: Mar. 1, 2007

(54) Receipt Card Systems

(76) Inventor: Ryan W. Dohse, Gilbert, AZ (US)

Correspondence Address: STONEMAN LAW OFFICES, LTD, 3113 NORTH 3RD STREET, PHOENIX, AZ, 85012, US

(21) Appl. No.: 11/468,669

(22) Filed: Aug. 30, 2006

Related U.S. Application Data
(60) Provisional application No. 60/713,670, filed on Sep. 1, 2005.

(51) Int. Cl. G06Q 30/00

(52) U.S. Cl. 705/14

(57) ABSTRACT

The receipt card system provides a system and method for accumulating and storing transaction line-item detail on behalf of consumers. The system permits consumers to view stored transaction line-item detail in a variety of ways using a web browser interface. It also includes a means for consumers to download transaction line-item detail into a personal financial management system. Transaction line-item detail is captured at each participating merchant's location at the time of transaction associated with a consumer and essentially automatically transferred to a centralized database. The system and method are essentially voluntary for both merchants and consumers.

### CROSS-REFERENCE TO RELATED APPLICATION

The present application is related to and claims priority from prior provisional application Ser. No. 60/713,670, filed Sep. 1, 2005, entitled “RECEIPT CARD SYSTEMS”, the contents of which are incorporated herein by this reference and are not admitted to be prior art with respect to the present invention by the mention in this cross-reference section.

### BACKGROUND

This invention relates to providing a system for improved accumulation and tracking of transaction data. More particularly this invention relates to providing an Internet website-based system for automated accumulation and tracking of line-item purchase data on behalf of consumers.

Today, many consumers routinely use Internet-based access to review and manage their bank and credit card accounts. Typically, consumers review transactional activity, transfer funds, pay bills and download copies of the transactions into a personal financial manager such as Intuit Quicken or Microsoft Money.

While access to transaction information for bank and credit card accounts is useful for overall management of the account, the purchase detail contained on the receipts would be very helpful in better managing a consumer's budgeting for expenses. For example, a single transaction may include many line items of details which are very disparate, some items may be groceries, other items may be for home maintenance, and other items may be for automobile maintenance or repair. Today, if a consumer wishes to track those items separately, the consumer must have the actual receipt in hand and then manually calculate the value of the various groups of items and finally enter the detail into a personal financial manager. This effort largely eliminates much of the benefit of downloading transactions.

Further, most merchants strongly prefer a physical receipt if a consumer wishes to return an item. Frequently, receipts, especially receipts for cash transactions, are lost or misplaced which makes it more difficult for both the merchant and the consumer to complete the return of an item. Currently, consumers have no method for re-creating a lost or misplaced receipt.

Thus, a great need exists for a system capable of effectively capturing and storing transaction line-item detail and then making it available to consumers via the Internet.

### OBJECTS AND FEATURES OF THE INVENTION

A primary object and feature of the present invention is to provide a system for accumulating and storing transaction line-item detail on behalf of consumers.

It is a further primary object and feature of the present invention to provide such a system for permitting consumers to view stored transaction line-item detail using a web browser.

It is a further primary object and feature of the present invention to provide such a system for permitting consumers to download transaction line-item detail into a personal financial management system.

A further primary object and feature of the present invention is to provide such a system that permits capturing transaction line-item detail at each participating merchant's location at the time of transaction and substantially automatically transferring the transaction line-item detail, associated with the consumer, to a centralized database.

A further primary object and feature of the present invention is to provide such a system that permits a participating consumer to manually input transaction line-item detail into a centralized database via a web browser interface.

Another primary object and feature of the present invention is to provide such a system that permits a participating consumer to select and reproduce a transaction receipt, acceptable as return item receipt by a participating merchant, from the stored transaction line-item detail.

Yet another primary object and feature of the present invention is to provide such a system that permits a participating consumer to create summary analysis reports from the stored transaction line-item detail, including the least expensive merchant for a selected product.

A further primary object and feature of the present invention is to provide such a system that permits a participating consumer to view and print coupons and rebate offers.

Another primary object and feature of the present invention is to provide such a system that permits participating merchants to receive summary purchase reporting.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a system, relating to centralized consumer assistance, comprising the steps of: receiving line-item data relating to at least one plurality of transactions between at least one consumer of at least one plurality of consumers and at least one plurality of sellers; electronically accumulating, in at least one transaction database, such line-item data relating to such at least one plurality of transactions on behalf of such at least one consumer; and permitting such at least one consumer to view such line-item data relating to such at least one plurality of transactions. Moreover, it provides such a system wherein the step of permitting such at least one consumer to view such line-item data comprises the step of using at least one Internet-based web site computer system. Additionally, it provides such a system wherein the step, receiving line-item data relating to at least one plurality of transactions between at least one consumer of at least one plurality of consumers and at least one plurality of sellers, comprises the step of electronically receiving such line-item data from such at least one seller. Also, it provides such a system further comprising the steps of: assigning at least one unique consumer identifier to such at least one consumer; and offering electronic accumulation of such line-item data to such at least one consumer. In addition, it provides such a system further comprising the steps of: providing at least one consumer identification card to such at least one consumer; wherein such at least one consumer identification card comprises such at least one unique consumer identifier; permitting use of such at least one unique consumer identifier for relating such line item data to such at least one consumer; and permitting use of such at least one consumer identification card for relating such line item data to such at least one consumer. And, it provides such a system further comprising the step of receiving at least one payment from such at least one consumer. Further, it provides such a system further comprising the steps of: receiving line-item data relating to such at least one transaction from such at least one consumer; and electronically accumulating, in such at least one transaction database, such inputted line-item data relating to such at least one transaction. Even further, it provides such a system further comprising the step of permitting electronic transfer of such accumulated line-item data to at least one computer program system controlled by such at least one consumer. Moreover, it provides such a system further comprising the steps of: permitting combining such at least one unique consumer identifier with at least one credit card provided to such at least one consumer by at least one credit card issuer; and permitting use of such at least one combined credit card for relating such line item data to such at least one consumer. Additionally, it provides such a system further comprising the steps of: permitting combining of such at least one unique consumer identifier with at least one loyalty card provided to such at least one consumer by at least one loyalty card issuer; and permitting use of such at least one combined loyalty card for relating such line item data to such at least one consumer. Also, it provides such a system further comprising the steps of: offering assistance with such electronic line-item data accumulation to such at least one seller; assigning at least one unique seller identifier to such at least one seller; receiving at least one payment on behalf of such at least one seller; and providing summarized line-item data reports to such at least one seller. In addition, it provides such a system further comprising the step of offering to present seller advertising to such at least one consumer on behalf of such at least one seller. And, it provides such a system wherein in such seller advertising is related to such line-item data related to such at least one consumer. Further, it provides such a system further comprising the steps of: offering to present manufacturer advertising to such at least one consumer on behalf of at least one manufacturer; assigning at least one unique manufacturer identifier on behalf of such at least one manufacturer; receiving at least one payment on behalf of such at least one manufacturer; and providing summarized line-item data reports on behalf of such at least one manufacturer. Even further, it provides such a system wherein in such manufacturer advertising is related to such line-item data related to such at least one consumer. Moreover, it provides such a system further comprising the step providing at least one coupon-based offer to such at least one consumer. Additionally, it provides such a system further comprising the steps of: electronically notifying such at least one consumer of such at least one coupon-based offer relating to such at least one transaction; and permitting printing, by such at least one consumer, of such at least one coupon-based offer. Also, it provides such a system wherein such at least one coupon-based offer is provided on behalf of such at least one seller. In addition, it provides such a system wherein such at least one coupon-based offer is provided by on behalf of such least one manufacturer. And, it provides such a system wherein in such coupon-based offer is related to such line-item data related to such at least one consumer. Further, it provides such a system further comprising the steps of: offering at least one rebate-based offer to such at least one consumer; electronically notifying such at least one consumer of such at least one rebate-based offer relating to such line-item data related to such at least one consumer; permitting completion, by such at least one consumer, of at least one rebate-based offer form relating to such at least one rebate-based offer; permitting printing, by such at least one consumer, of at least one rebate-based offer form; permitting electronic submission, by such at least one consumer, of completed such at least one rebate-based offer form to at least one rebate-based offer provider; and electronically providing to such at least one consumer at least one expiration reminder notice related to such at least one rebate-based offer. Even further, it provides such a system wherein such at least one rebate-based offer is provided on behalf of such at least one seller. Moreover, it provides such a system wherein such at least one rebate-based offer is provided on behalf of at such least one manufacturer. Additionally, it provides such a system wherein such line-item data is substantially sufficient to replicate such at least one transaction. Also, it provides such a system wherein such line-item data comprises at least: at least one transaction identifier; at least one transaction date; at least one seller identifier; at least one product identifier of at least one product; and at least one selling price of such at least one product. In addition, it provides such a system wherein such line-item data further comprises at least three of the following: at least one amount tendered; at least one payment method; at least one sales tax amount; at least one discount amount; and at least one discount identifier of such at least one discount amount received. And, it provides such a system further comprising the step of providing line-item data reports to such at least one consumer. Further, it provides such a system further comprising the steps of: permitting electronic summarization of such line-item data; and permitting at least one graphical presentation of such summarized such line item data. Even further, it provides such a system wherein such summarization of line-item data is by such at least one product identifier. Moreover, it provides such a system wherein such summarization of line-item data is by such at least one seller identifier. Additionally, it provides such a system wherein summarization of line-item data is by such at least one manufacturer identifier. Also, it provides such a system wherein such summarization of line-item data is by at least one time period. In addition, it provides such a system further comprising the step of permitting identification, by such at least one consumer, of such at least one seller offering such at least one product least expensively.

In accordance with another preferred embodiment hereof, this invention provides a computer program system for an Internet computer web site system, relating to centralized consumer assistance, comprising the steps of: electronically receiving line-item data relating to at least one plurality of transactions between at least one consumer of at least one plurality of consumers and at least one seller of at least one plurality of sellers; storing, in at least one transaction database, such line-item data relating to such at least one plurality of transactions; and permitting viewing by such at least one consumer of such line-item data relating to such at least one plurality of transactions. And, it provides such a computer program system further comprising the steps of: permitting input by such at least one consumer of at least one consumer profile; assigning at least one unique consumer identifier to such at least one consumer; storing such at least one consumer profile in at least one consumer database; encoding at least one consumer identification card with such at least one unique consumer identifier; and associating such line-item data with such at least one unique consumer identifier. Further, it provides such a computer program system further comprising the steps of: permitting input by such at least one consumer of such line-item data relating to such at least one transaction; and storing, in such at least one transaction database, such inputted line-item data. Even further, it provides such a computer program system further comprising the step of permitting electronic transfer of such stored line-item data to at least one computer program system controlled by such at least one consumer. Moreover, it provides such a computer program system further comprising the steps of: electronically receiving at least one seller profile on behalf of such at least one seller; wherein such at least one seller profile comprises at least one seller identifier; and storing such at least one seller profile in at least one seller database. Additionally, it provides such a computer program system further comprising the steps of: electronically receiving at least one manufacturer profile on behalf of at least one manufacturer; wherein such at least one seller profile comprises at least one manufacturer identifier; and storing such at least one manufacturer profile in at least one manufacturer database. Also, it provides such a computer program system further comprising the steps of: electronically receiving at least one advertisement; storing such at least one advertisement in at least one advertisement database; and presenting such stored such at least one advertisement to such at least one consumer. In addition, it provides such a computer program system further comprising the step of relating such at least one advertisement to such line-item data related to such at least one consumer. And, it provides such a computer program system wherein such at least one advertisement is provided on behalf of such at least one seller. Further, it provides such a computer program system wherein such at least one advertisement is provided on behalf of at such least one manufacturer. Even further, it provides such a computer program system further comprising the steps of: electronically receiving at least one coupon-based offer; providing at least one coupon-based offer to such at least one consumer; electronically notifying such at least one consumer of such at least one coupon-based offer; and permitting printing, by such at least one consumer, of such at least one coupon-based offer form relating to such at least one coupon-based offer. Moreover, it provides such a computer program system further comprising the step of relating such at least one coupon-based offer to such line-item data related to such at least one consumer. Additionally, it provides such a computer program system wherein such at least one coupon-based offer is provided on behalf of such at least one seller. Also, it provides such a computer program system wherein such at least one coupon-based offer is provided on behalf of at such least one manufacturer. In addition, it provides such a computer program system further comprising the steps of: electronically receiving at least one rebate-based offer; providing at least one rebate-based offer to such at least one consumer; electronically notifying such at least one consumer of such at least one rebate-based offer related to such line-item data related to such at least one consumer; and permitting printing, by such at least one consumer, of such at least one rebate-based offer form relating to such at least one rebate-based offer. And, it provides such a computer program system wherein such at least one rebate-based offer is provided on behalf of such at least one seller. Further, it provides such a computer program system wherein such at least one rebate-based offer is provided on behalf of at such least one manufacturer. Even further, it provides such a computer program system wherein such line-item data is substantially sufficient to replicate such at least one transaction. Moreover, it provides such a computer program system wherein such line-item data comprises at least: at least one transaction identifier; at least one transaction date; such at least one seller identifier; at least one product identifier of at least one product; and at least one selling price of such at least one product. Additionally, it provides such a computer program system wherein such line-item data further comprises at least three of the following: at least one amount tendered; at least one payment method; at least one sales tax amount; at least one discount amount; and at least one discount identifier of such at least one discount amount received. Also, it provides such a computer program system further comprising the step of electronically providing line-item data reports to such at least one consumer. In addition, it provides such a computer program system further comprising the steps of: electronic summarization of such line-item data; and permitting viewing at least one graphical presentation of such summarized such line item data. And, it provides such a computer program system wherein such summarization of line-item data is by such at least one product identifier. Further, it provides such a computer program system wherein such summarization of line-item data is by such at least one seller identifier. Even further, it provides such a computer program system wherein such summarization of line-item data is by such at least one manufacturer identifier. Moreover, it provides such a computer program system wherein such summarization of line-item data is by at least one time period. Additionally, it provides such a computer program system further comprising the step of electronically providing such summarized line-item data on behalf of such at least one seller. Also, it provides such a computer program system further comprising the step of electronically providing such summarized line-item data on behalf of such at least one manufacturer. In addition, it provides such a computer program system further comprising the step of permitting identification, by such at least one consumer, of such at least one seller offering such at least one product least expensively.

In accordance with another preferred embodiment hereof, this invention provides a system for an Internet computer web site system, relating to centralized consumer assistance, comprising: computer processor means for receiving line-item data relating to at least one plurality of transactions between at least one consumer of at least one plurality of consumers and at least one seller of at least one plurality of sellers; computer database means for storing, in at least one transaction database, such line-item data relating to such at least one plurality of transactions; and computer interface means for permitting viewing by such at least one consumer of such line-item data relating to such at least one plurality of transactions. And, it provides such a system further comprising: computer interface means for permitting input by such at least one consumer of at least one consumer profile; computer processor means for assigning at least one unique consumer identifier to such at least one consumer; computer database means for storing such at least one consumer profile in at least one consumer database. Further, it provides such a system further comprising: computer interface means for permitting input by such at least one consumer of such line-item data relating to such at least one transaction; and computer database means for storing, in such at least one transaction database, such inputted line-item data. Even further, it provides such a system further comprising computer processor means for transfer of such stored line-item data to at least one computer program system controlled by such at least one consumer. Even further, it provides such a system further comprising the steps of: computer processor means for receiving at least one seller profile on behalf of such at least one seller; wherein such at least one seller profile comprises at least one seller identifier; and computer database means for storing such at least one seller profile in at least one seller database. Even further, it provides such a system further comprising: computer processor means for receiving at least one manufacturer profile on behalf of at least one manufacturer; wherein such at least one seller profile comprises at least one manufacturer identifier; and computer database means for storing such at least one manufacturer profile in at least one manufacturer database. Even further, it provides such a system further comprising: computer processor means for receiving at least one advertisement; computer database means for storing such at least one advertisement in at least one advertisement database; and computer interface means for presenting such stored such at least one advertisement to such at least one consumer. Even further, it provides such a system further comprising computer processor means for relating such at least one advertisement to such line-item data related to such at least one consumer. Even further, it provides such a system wherein such at least one advertisement is provided on behalf of such at least one seller. Even further, it provides such a system wherein such at least one advertisement is provided on behalf of at such least one manufacturer. Even further, it provides such a system further comprising: computer processor means for receiving at least one coupon-based offer; computer processor means for providing at least one coupon-based offer to such at least one consumer; computer processor means for notifying such at least one consumer of such at least one coupon-based offer; and computer interface means for permitting printing, by such at least one consumer, of such at least one coupon-based offer form relating to such at least one coupon-based offer. Even further, it provides such a system further comprising computer processor means for relating such at least one coupon-based offer to such line-item data related to such at least one consumer. Even further, it provides such a system wherein such at least one coupon-based offer is provided on behalf of such at least one seller. Even further, it provides such a system wherein such at least one coupon-based offer is provided on behalf of at such least one manufacturer. Even further, it provides such a system further comprising: computer processor means for receiving at least one rebate-based offer; computer processor means for providing at least one rebate-based offer to such at least one consumer; computer processor means for notifying such at least one consumer of such at least one rebate-based offer related to such line-item data related to such at least one consumer; and computer interface means for permitting printing, by such at least one consumer, of such at least one rebate-based offer form relating to such at least one rebate-based offer. Even further, it provides such a system 5 wherein such at least one rebate-based offer is provided on behalf of such at least one seller. Even further, it provides such a system wherein such at least one rebate-based offer is provided on behalf of at such least one manufacturer. Even further, it provides such a system wherein such line-item data is substantially sufficient to replicate such at least one transaction. Even further, it provides such a system further comprising computer processor means for providing line-item data reports to such at least one consumer. Even further, it provides such a system further comprising the steps of: computer processor means for summarization of such line-item data; and computer interface means for viewing at least one graphical presentation of such summarized such line item data. Even further, it provides such a system further comprising computer processor means for identification, by such at least one consumer, of such at least one seller offering such at least one product least expensively.

In accordance with a preferred embodiment hereof, this invention provides a system, relating to centralized consumer assistance, comprising the steps of: receiving line-item data relating to at least one plurality of transactions between at least one consumer of at least one plurality of consumers and at least one plurality of sellers; electronically accumulating, in at least one transaction database, such line-item data relating to such at least one plurality of transactions on behalf of such at least one consumer; and permitting such at least one consumer to view such line-item data relating to such at least one plurality of transactions. Moreover, it provides such a system wherein the step of permitting such at least one consumer to view such line-item data comprises the step of using at least one Internet-based-web-site computer system. Additionally, it provides such a system wherein the step, of receiving line-item data relating to at least one plurality of transactions between at least one consumer of at least one plurality of consumers and at least one plurality of sellers, comprises the step of electronically receiving such line-item data from such at least one seller. Also, it provides such a system further comprising the steps of: offering electronic accumulation of such line-item data to such at least one consumer; assigning at least one unique consumer identifier to such at least one consumer; providing at least one consumer identification card to such at least one consumer; wherein such at least one consumer identification card comprises such at least one unique consumer identifier; permitting use of such at least one unique consumer identifier to relate such line item data to such at least one consumer; and permitting use of such at least one consumer identification card to relate such line item data to such at least one consumer. In addition, it provides such a system further comprising the step of receiving at least one payment from such at least one consumer relating to such accumulating. And, it provides such a system further comprising the step of permitting electronic transfer of such accumulated line-item data to at least one computer program system controlled by such at least one consumer. Further, it provides such a system further comprising the steps of: permitting combining such at least one unique consumer identifier with at least one credit card provided to such at least one consumer by at least one credit card issuer; permitting use of such at least one combined credit card for relating such line item data to such at least one consumer; and electronically receiving such related line-item data from such at least one credit card issuer. Even further, it provides such a system further comprising the steps of: permitting combining of such at least one unique consumer identifier with at least one loyalty card provided to such at least one consumer by at least one loyalty card issuer; permitting use of such at least one combined loyalty card for relating such line item data to such at least one consumer; and electronically receiving such related line-item data from such at least one loyalty card issuer. Moreover, it provides such a system further comprising the steps of: electronically receiving at least one coupon-based offer; relating such at least one coupon-based offer to such line-item date; electronically notifying such at least one consumer of such at least one coupon-based offer related to such line-item data; and permitting printing, by such at least one consumer, of such at least one coupon-based offer. Additionally, it provides such a system further comprising the steps of: electronically receiving at least one rebate-based offer; relating such at least one rebate-based offer to such line-item date; offering at least one rebate-based offer to such at least one consumer; electronically notifying such at least one consumer of such at least one rebate-based offer relating to such line-item data; permitting completion, by such at least one consumer, of at least one rebate-based offer form relating to such at least one rebate-based offer; permitting printing, by such at least one consumer, of at least one rebate-based offer form; permitting electronic submission, by such at least one consumer, of completed such at least one rebate-based offer form to at least one rebate-based offer provider; and electronically providing to such at least one consumer at least one first expiration reminder notice related to such at least one rebate-based offer. Also, it provides such a system further comprising the steps of: electronically receiving at least one warranty-based offer related to such line-item data; electronically notifying such at least one consumer of such at least one warranty-based offer; and electronically providing to such at least one consumer at least one second expiration reminder notice related to such at least one warranty-based offer. In addition, it provides such a system further comprising the steps of: offering assistance with such electronic line-item data accumulation to such at least one seller; assigning at least one unique seller identifier to such at least one seller; receiving at least one payment on behalf of such at least one seller; and providing at least one summarized line-item data report to such at least one seller. And, it provides such a system further comprising the steps of: offering to present advertising to such at least one consumer on behalf of at least one advertiser; assigning at least one unique advertiser identifier on behalf of such at least one advertiser; receiving at least one payment on behalf of such at least one advertiser; and providing at least one summarized line-item data report on behalf of such at least one advertiser. Further, it provides such a system wherein such line-item data is substantially sufficient to replicate such at least one transaction. Even further, it provides such a system comprising the step of electronically transmitting such replicated at least one transaction using electronic messaging to at least one electronic device, capable of receiving such electronic messages, controlled by such at least one consumer. Moreover, it provides such a system further comprises the step of providing at least one line-item data report to such at least one consumer. Additionally, it provides such a system further comprising the step of permitting identification, by such at least one consumer, of such at least one seller offering such at least one product least expensively.

In accordance with another preferred embodiment hereof, this invention provides a computer program system for an Internet computer web site system, relating to centralized consumer assistance, comprising the steps of: electronically receiving line-item data relating to at least one plurality of transactions between at least one consumer of at least one plurality of consumers and at least one seller of at least one plurality of sellers; storing, in at least one transaction database, such line-item data relating to such at least one plurality of transactions; and permitting viewing by such at least one consumer of such line-item data relating to such at least one plurality of transactions. Also, it provides such a computer program system further comprising the steps of: permitting input by such at least one consumer of at least one consumer profile; assigning at least one unique consumer identifier to such at least one consumer; storing such at least one consumer profile in at least one consumer database; encoding at least one consumer identification card with such at least one unique consumer identifier; and associating such line-item data with such at least one unique consumer identifier. In addition, it provides such a computer program system further comprising the steps of: permitting input by such at least one consumer of such line-item data relating to such at least one transaction; and storing, in such at least one transaction database, such inputted line-item data. And, it provides such a computer program system further comprising the step of permitting electronic transfer of such stored line-item data to at least one computer program system controlled by such at least one consumer. Further, it provides such a computer program system further comprising the steps of: electronically receiving at least one seller profile on behalf of such at least one seller; wherein such at least one seller profile comprises at least one seller identifier; and storing such at least one seller profile in at least one seller database. Even further, it provides such a computer program system further comprising the steps of: electronically receiving at least one manufacturer profile on behalf of at least one manufacturer; wherein such at least one seller profile comprises at least one manufacturer identifier; and storing such at least one manufacturer profile in at least one manufacturer database. Moreover, it provides such a computer program system further comprising electronically receiving at least one warranty-based offer related to such line-item data related to such at least one consumer; electronically notifying such at least one consumer of at least one warranty-based offer; and electronically providing to such at least one consumer at least one second expiration reminder notice related to such at least one warranty-based offer. Additionally, it provides such a computer program system further comprising the steps of: electronically providing such summarized line-item data on behalf of such at least one seller; and electronically providing such summarized line-item data on behalf of such at least one manufacturer. Also, it provides such a computer program system further comprising the step of permitting identification, by such at least one consumer, of such at least one seller offering such at least one product least expensively. In addition, it provides such a computer program system further comprising the steps of: electronically receiving at least one advertisement; storing such at least one advertisement in at least one advertisement database; and presenting such stored such at least one advertisement to such at least one consumer. And, it provides such a computer program system further comprising the step of relating such at least one advertisement to such line-item data related to such at least one consumer. Further, it provides such a computer program system further comprising the steps of: electronically receiving at least one coupon-based offer; providing at least one coupon-based offer to such at least one consumer; electronically notifying such at least one consumer of such at least one coupon-based offer; permitting printing, by such at least one consumer, of such at least one coupon-based offer form relating to such at least one coupon-based offer; and relating such at least one coupon-based offer to such line-item data related to such at least one consumer. Even further, it provides such a computer program system further comprising the steps of: electronically receiving at least one rebate-based offer; providing at least one rebate-based offer to such at least one consumer; electronically notifying such at least one consumer of such at least one rebate-based offer related to such line-item data related to such at least one consumer; permitting printing, by such at least one consumer, of such at least one rebate-based offer form relating to such at least one rebate-based offer; and electronically providing to such at least one consumer at least one first expiration reminder notice related to such at least one rebate-based offer. Even further, it provides such a computer program system wherein such line-item data is substantially sufficient to replicate such at least one transaction. Even further, it provides such a system further comprising the step of transmitting such replicated transaction using electronic messaging to at least one electronic device, capable of receiving such electronic messages, controlled by such at least one consumer. Even further, it provides such a computer program system further comprising the step of electronically providing line-item data reports to such at least one consumer.

In accordance with another preferred embodiment hereof, this invention provides a system for an Internet computer web site system, relating to centralized consumer assistance, comprising: at least one computer processor structured and arranged to receive line-item data relating to at least one plurality of transactions between at least one consumer of at least one plurality of consumers and at least one seller of at least one plurality of sellers; at least one computer database structured and arranged to store, in at least one transaction database, such line-item data relating to such at least one plurality of transactions; wherein such line-item data is substantially sufficient to replicate such at least one transaction; at least one computer interface structured and arranged to permit viewing by such at least one consumer of such line-item data relating to such at least one plurality of transactions; at least one computer processor structured and arranged to receive at least one advertisement; at least one computer database structured and arranged to store such at least one advertisement in at least one advertisement database; at least one computer interface structured and arranged to present such stored such at least one advertisement to such at least one consumer; at least one computer processor structured and arranged to relate such at least one advertisement to such line-item data related to such at least one consumer; at least one computer processor structured and arranged to receive at least one coupon-based offer; at least one computer processor structured and arranged to provide at least one coupon-based offer to such at least one consumer; at least one computer processor structured and arranged to notify such at least one consumer of such at least one coupon-based offer; at least one computer interface structured and arranged to permit printing, by such at least one consumer, of such at least one coupon-based offer form relating to such at least one coupon-based offer; at least one computer processor structured and arranged to transmit such at least one transaction using electronic messaging to at least one electronic device, capable of receiving such electronic messages, controlled by such at least one consumer; at least one computer processor structured and arranged to provide at least one line-item data report to such at least one consumer; at least one computer processor structured and arranged to identify, by such at least one consumer, such at least one seller offering such at least one product least expensively; at least one computer processor structured and arranged to receive at least one rebate-based offer; at least one computer processor structured and arranged to relate such at least one rebate-based offer to such line-item date; at least one computer processor structured and arranged to offer at least one rebate-based offer to such at least one consumer; at least one computer processor structured and arranged to notify such at least one consumer of such at least one rebate-based offer relating to such line-item data; at least one computer processor structured and arranged to permit completion, by such at least one consumer, of at least one rebate-based offer form relating to such at least one rebate-based offer; at least one computer processor structured and arranged to permit printing, by such at least one consumer, of at least one rebate-based offer form; at least one computer processor structured and arranged to permit electronic submission, by such at least one consumer, of completed such at least one rebate-based offer form to at least one rebate-based offer provider; at least one computer processor structured and arranged to provide to such at least one consumer at least one first expiration reminder notice related to such at least one rebate-based offer; at least one computer processor structured and arranged to receive at least one warranty-based offer related to such line-item data related to such at least one consumer; at least one computer processor structured and arranged to notify such at least one consumer of at least one warranty-based offer; and at least one computer processor structured and arranged to provide to such at least one consumer at least one second expiration reminder notice related to such at least one warranty-based offer.

### DEFINITIONS, ACRONYMS AND CROSS-REFERENCES

The following terms and acronyms are explained below as background and are used throughout the detailed description:

Client-Server. A model of interaction in a distributed system in which a program at one site sends a request to a program at another site and waits for a response. The requesting program is called the “client,” and the program that responds to the request is called the “server.” In the context of the World Wide Web, the client is typically a “Web browser” that runs on a user's computer; the program that responds to Web browser requests at a Web site is commonly referred to as a “Web server.”

Database. One or more large structured sets of persistent data maintained upon a computer system organized and structured according to a software system defining rules for organization as well responding to queries to read, write or modify data as well as provide statistical information regarding the contained data. As used herein for purposes of discussion, a database may be either a single unified system or a distributed system wherein certain database elements are located upon different systems, acting in harmony to appear as one unified database.

Domain Name System (DNS). An Internet service that translates domain names (which are alphabetic identifiers) into IP addresses (which are numeric identifiers for machines on a TCP/IP network).

Email. A system for sending and receiving messages electronically over a computer network, as between personal computers.

Extensible Markup Language (XML). XML describes a class of data objects known as XML documents and partially describes the behavior of computer programs which process these documents. More specifically, XML is a restricted form of the Standard Generalized Markup Language (also known as SGML). XML documents are made up of storage units defined as entities which in turn comprise either parsed or unparsed data in the form of characters or simply a character. XML is designed and intended to improve the functionality of the Internet by providing more flexible and adaptive forms of information. XML can be used to store any kind of structured information and in such encapsulated form, pass it between different computer systems which would otherwise be unable to communicate.

Hypertext Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other web sites and other Web documents (commonly referred to as “hyperlinks”). For more information on HTML, see Ian S. Graham, The HTML Source Book, John Wiley and Sons, Inc., 1995 (ISBN 0471-11894-4).

Hypertext Transport Protocol (HTTP). The standard World Wide Web client-server protocol used for the exchange of information (such as HTML documents and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

HTTPS. HTTP over SSL (Secure Sockets Layer) can be best understood as a secure form of HTTP communication. Specifically, SSL is a protocol utilized for the authentication and encryption of HTTP traffic. In operation, the server and client exchange a set of encryption keys that are used to create a unique encryption key used to encrypt all data exchanged during the session.

Inline FRAME. A floating frame, with content just like an ordinary frame, included in the HTML 4 standard. Inline Frames are useful for maintaining a frame of information on the user's display at all time even when the underlying content is scrolled up or down.

Instant Messaging. Abbreviated IM, a type of communications service that enables you to create a kind of private chat room with another individual in order to communicate in real time over the Internet, analogous to a telephone conversation but using text-based, not voice-based, communication. Typically, the instant messaging system alerts you whenever somebody on your private list is online. You can then initiate a chat session with that particular individual.

Internet. A collection of interconnected (public and/or private) networks that are linked together by a set of standard protocols to form a distributed network. While this term is intended to refer to what is now commonly known as the Internet, it is also intended to encompass variations that may be made in the future, including changes and additions to existing standard protocols.

LAN. A Local Area Network of computer systems, typically within a building or office, permitting networking, the associated sharing of resources and files, such as application software, printers and client information, in an inter-office setting.

PHP. A server-side, cross-platform, HTML-embedded scripting language used to create dynamic web pages. PHP is Open Source software.

Short Message Service (SMS). A service available on most digital mobile phones (and other mobile devices, e.g. a Pocket PC, or occasionally even desktop computers) that permits the sending of short messages (also known as text messages, or more colloquially SMSes, texts or even txts) between mobile phones, other handheld devices and even landline telephones. Messages are sent via a store-and-forward mechanism to a Short Message Service Center (SMSC), which will attempt to send the message to the recipient. If the user is not reachable at a given moment, the SMSC will save the message. Later when the user is reachable, the SMSC will retry the delivery process.

Structured Query Language (SQL). SQL is a standard language used to communicate with relational database management systems (such as Oracle, Sybase, Microsoft SQL Server, Access, etc.) for the purpose of performing tasks such as data insertion, deletion, update, and general query for the return of data.

The Simple Object Access Protocol (SOAP). SOAP is a lightweight XML/HTTP-based protocol for the exchange of information in a decentralized distributed platform-independent environment. Fundamentally, SOAP consists of three parts. The first is an envelope that defines a framework for describing what is contained in the message and how it should be processed. The second is a set of encoding rules for expressing instances of application-defined data types. The third is a normalized convention for representing remote procedure calls and responses.

Transmission Control Protocol/Internet Protocol (TCP/IP). A standard Internet protocol (or set of protocols) which specifies how two computers exchange data over the Internet. TCP/IP handles issues such as packetization, packet addressing, and handshaking and error correction. For more information on TCP/IP, see Volumes I, II and III of Comer and Stevens, Internetworking with TCP/IP, Prentice Hall, Inc., ISBNs 0-13-468505-9 (vol. I), 0-13-125527-4 (vol. II), and 0-13-474222-2 (vol. III).

Uniform Resource Locator (URL). A unique address which fully specifies the location of a file or other resource on the Internet. The general format of a URL is protocol://machine address:port/path/filename. The port specification is optional, and, if not entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

WAN. A Wide Area Network, such as the Internet.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the Hypertext Transfer Protocol (HTTP), and the electronic pages are encoded using the Hypertext Markup Language (HTML). However, the terms “World Wide Web” and “Web” are intended to encompass future markup languages and transport protocols that may be used in place of or in addition to the Hypertext Markup Language (HTML) and the Hypertext Transfer Protocol (HTTP).

### BRIEF DESCRIPTION OF THE DRAWINGS

FIG. 1 shows a schematic overview view illustrating the primary concepts embodied in the receipt card system according to a preferred embodiment of the present invention.

FIG. 2 shows a simplified functional diagrammatical overview of the primary processes of the receipt card system according to a preferred embodiment of the present invention.

FIG. 3 shows a simplified functional diagrammatical overview of the manufacturer processes of the receipt card system according to a preferred embodiment of the present invention.

FIG. 4 shows a summary schematic of the primary receipt card system computer-based functions available to a consumer through the website according to a preferred embodiment of the present invention.

FIG. 5 shows an overall schematic depicting the transaction flows and relationships between the primary components and entities of the receipt card system according to the preferred embodiment of the present invention.

FIG. 6 shows a schematic of the data flows and primary databases utilized by the receipt database system according to a preferred embodiment of the present invention.

FIG. 7 shows a depiction of alternative consumer identification cards used by a consumer at the time of a purchase according to a preferred embodiment of the present invention.

FIG. 8 shows a depiction of a sample website home page for the receipt card system according to a preferred embodiment of the present invention.

FIG. 9 shows a depiction of a sample member's first website page for the receipt card system according to a preferred embodiment of the present invention.

FIG. 10 shows a depiction of an example report of product purchases for a consumer generated by the receipt card system according to a preferred embodiment of the present invention.

### DETAILED DESCRIPTION OF THE BEST MODES AND PREFERRED EMBODIMENTS OF THE INVENTION

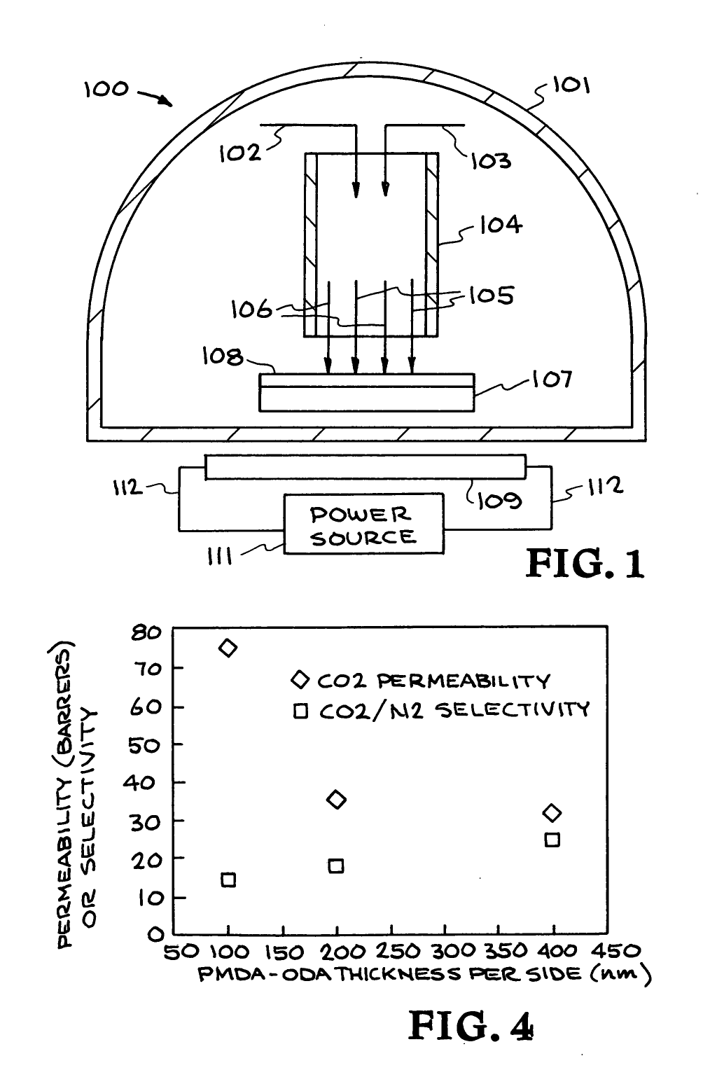

Referring to FIG. 1, a schematic overview view illustrating the primary concepts embodied in Receipt Card System 100 according to a preferred embodiment of the present invention, Receipt Card System 100 preferably provides a method and system for accumulating line-item detail for transactions between participating merchants and participating consumers.

As shown, Consumer 101 completes different transactions with a variety of merchants as exemplified by Purchase Transaction 121 completed with Merchant A 103, Purchase Transaction 125 completed with Merchant B 105, Purchase Transaction 119 completed with Merchant C 107, Purchase Transaction 127 completed with Merchant D 109, and Purchase Transaction 129 completed with Merchant E 111. Presentation of Receipt Card 531 to each of the merchants initiates process Transaction Data Transfer 123 which preferably transfers substantially all line-item detail related to each transaction to Receipts Database 113.

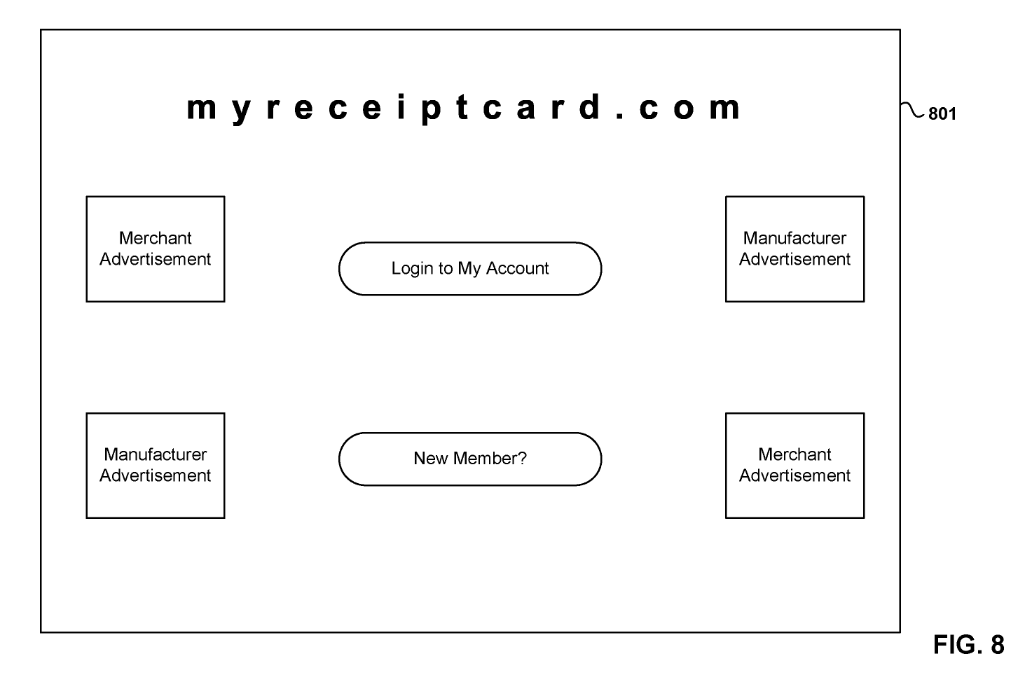

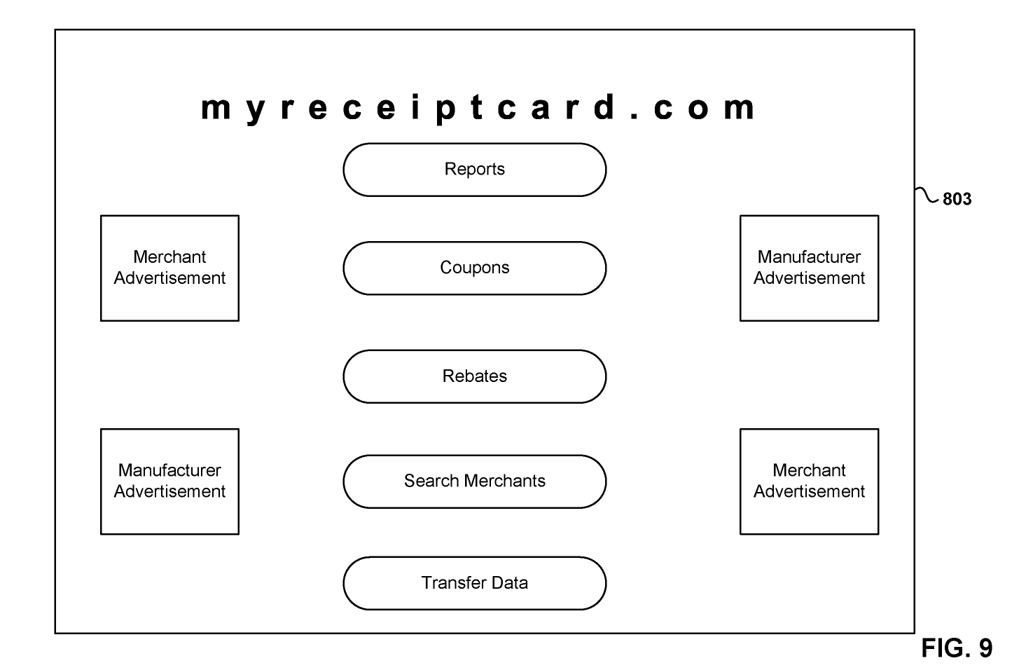

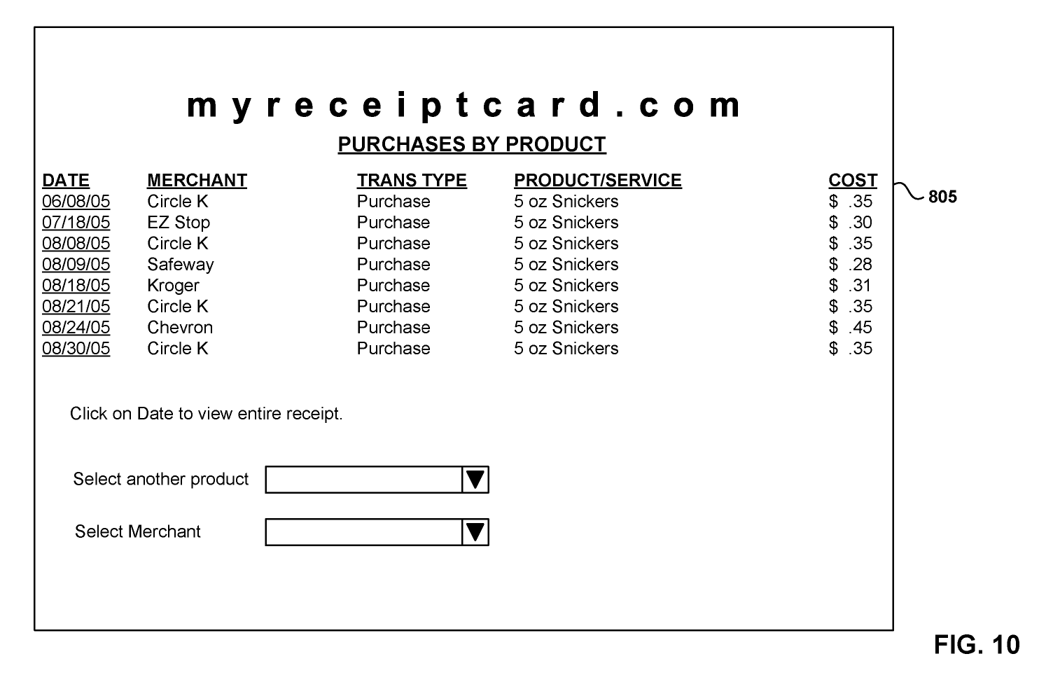

Receipt Card System 100 preferably permits consolidation of line-item detail for Purchase Transaction 119, Purchase Transaction 121, Purchase Transaction 125, Purchase Transaction 127, and Purchase Transaction 129 into Receipts Database 113 regardless of payment method used (such as check, cash or credit card). Further, as shown in process Database Access 135, Receipt Card System 100 preferably permits Consumer 101 to access Receipts Database 113 to view the accumulated line-item detail in a variety of Reports 131 via the Internet through Consumer Interface 803 (see FIG. 8, FIG. 9 and FIG. 10) which is web-browser based (at least herein embodying permitting such at least one consumer to view such line-item data relating to such at least one plurality of transactions; and at least herein embodying using at least one Internet-based web site computer system). Additionally, preferably Consumer 101 may use Digital Mobile Phone 221 (or similar wireless device, such as a personal digital assistant) that is capable of accessing Website 215 via Internet 543 to access the stored line-item detail. Preferably, Consumer 101 may receive SMS (or similar) electronic text messages containing transaction line-item detail that are sent to a wireless device, such as Digital Mobile Phone 221 (at least herein embodying electronically transmitting such replicated at least one transaction using electronic messaging to at least one electronic device, capable of receiving such electronic messages, controlled by such at least one consumer). Upon reading the teachings of this specification, those with ordinary skill in the art will now understand that, under appropriate circumstances, considering such issues as advances in technology, consumer preferences, user location, etc., other personal digital assistants capable of wireless connection to the Internet, such as BlackBerry® offered by Research in Motion Limited, Treo™ offered by Palm, Inc., etc., may suffice. Additionally, as part of process Database Access 135, preferably Consumer 101 may print Receipt 133, in sufficient line-item detail to re-create a purchase receipt that is acceptable for merchandise returns at merchants (represented by Merchant A 103, Merchant B 105, Merchant C 107, Merchant D 109 and Merchant E 111) participating in process Transaction Data Transfer 123. Preferably purchase receipts may also be created as gift receipts, which do not include item pricing, for use by gift recipients for merchandise returns at merchants (represented by Merchant A 103, Merchant B 105, Merchant C 107, Merchant D 109 and Merchant E 111) participating in process Transaction Data Transfer 123.

Preferably, Receipt Card System 100 also comprises process Merchant Access 137 which include preparation of Summary Analyses 139, a summary of purchase activity for each merchant (represented by Merchant A 103, Merchant B 105, Merchant C 107, Merchant D 109 and Merchant E 111) participating in process Transaction Data Transfer 123.

These and additional functions and capabilities are further described below.

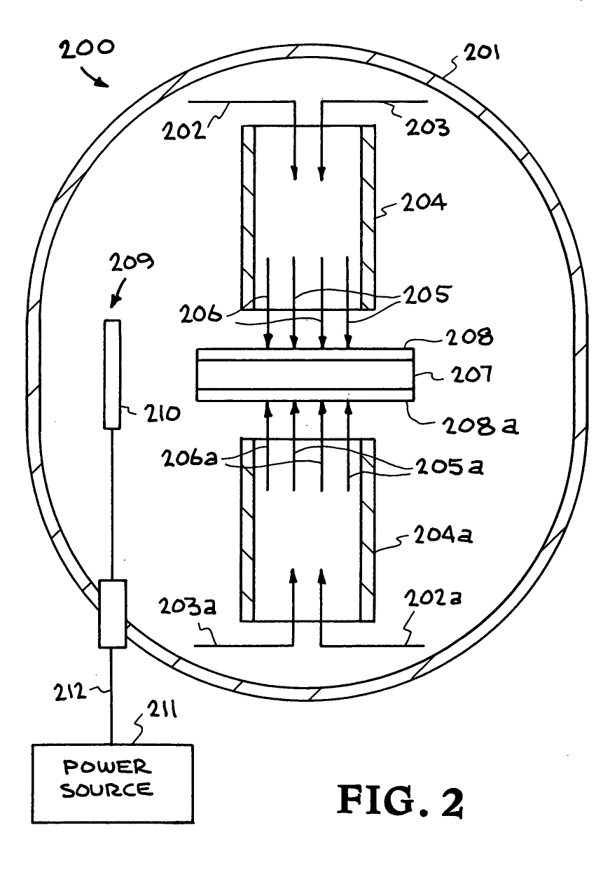

Referring to FIG. 2, a simplified functional diagrammatical overview of the primary processes of the Receipt Card System 100 according to a preferred embodiment of the present invention, in step Sign License Agreement 201 Manager 200 preferably signs a license agreement with Merchant A 103 (at least herein embodying offering assistance with such electronic line-item data accumulation to such at least one seller). The license agreement preferably obligates Merchant A 103 to transfer line-item detail for each transaction when Consumer 101 presents Receipt Card 531 or provides their unique receipt card identification number. In turn, Manager 200 preferably commits to assign a unique identifier to Merchant A 103, permit Merchant A 103 to optionally offer coupon and rebate information, which may be related to line-item detail, through Website 215 and to provide Merchant A 103 summary reports related to transaction activity with Merchant A 103 (at least herein embodying assigning at least one unique seller identifier to such at least one seller; and at least embodying herein providing summarized line-item data reports to such at least one seller). Preferably, Merchant A 103 may also optionally provide advertising to be displayed on Website 215. Further, Merchant A 103 preferably agrees to pay required fees associated with services provided by Manager 200 (at least herein embodying receiving at least one payment on behalf of such at least one seller). Upon reading the teachings of this specification, those with ordinary skill in the art will now understand that, under appropriate circumstances, considering such issues as advances in technology, changes in the competitive environment, advertising, coupons and rebate information may be provided by other merchants, such as those not licensed to transfer line-item data, etc., may suffice.

According to a first alternate preferred embodiment receipt card identification information (including receipt card identification number) may be combined with one or more credit cards (issued by one or more credit card issuers) to eliminate the need to carry a separate Receipt Card 531 for Consumer 101 (at least herein embodying permitting combining such at least one unique consumer identifier with at least one credit card provided to such at least one consumer by at least one credit card issuer). Preferably, this requires completion of an agreement between a credit card issuer and Manager 200 to permit inclusion of receipt card identification information (including receipt card identification number) on the magnetic strip or as a barcode on the back of the credit card or some similar arrangement. Upon reading the teachings of this specification, those with ordinary skill in the art will now understand that, under appropriate circumstances, considering such issues as advances in technology, preferences of credit card issuers, user location, etc., other methods of relating receipt card identification information to a consumer's credit cards, such as specialized credit card numbering schemes, specialized credit card types, etc., may suffice. As used herein, the term credit card comprises credit cards, debit cards, charge cards, and gift cards or other similar forms of payment accepted by merchants in lieu of cash.

Preferably, when Receipt Card 531 is combined with one or more credit cards (issued by one or more credit card issuers) step Provide Purchase Data 213 may comprise receiving line-item detail from one or more credit card issuers (at least herein embodying electronically receiving such related line-item data from such at least one credit card issuer).

According to a second alternate preferred embodiment receipt card identification information (including receipt card identification number) may be combined with one or more customer loyalty cards to eliminate the need to carry a separate Receipt Card 531 for Consumer 101 (at least herein embodying permitting combining of such at least one unique consumer identifier with at least one loyalty card provided to such at least one consumer by at least one loyalty card issuer). Preferably, this requires completion of an agreement between the customer loyalty card issuer (which may be Merchant A 103) and Manager 200 to permit inclusion of receipt card identification information (including receipt card identification number) on the magnetic strip or as a barcode on the back of the customer loyalty card or some similar arrangement. Upon reading the teachings of this specification, those with ordinary skill in the art will now understand that, under appropriate circumstances, considering such issues as advances in technology, preferences of loyalty card issuers, user location, etc., other methods of relating receipt card identification information to a consumer's loyalty card, such as specialized loyalty card numbering schemes, etc., may suffice.

Preferably, when Receipt Card 531 is combined with one or more customer loyalty cards (issued by one or more customer loyalty card issuers) step Provide Purchase Data 213 may comprise receiving line-item detail from one or more customer loyalty card issuers (at least herein embodying electronically receiving such related line-item data from such at least one loyalty card issuer).

Upon completion of a licensing agreement between Manager 200 and Merchant A 103, as shown in step Implement Receipt Card POS 203, Manager 200 preferably arranges for and assists Merchant A 103 in the installation of Receipt Card POS 533 (which preferably includes point-of-sale software and/or hardware for accepting Receipt Card 531 and necessary software and/or hardware to interface Receipt Card POS 533 with Merchant POS 525) at the retail locations of Merchant A 103. Preferably, Receipt Card POS 533 works in combination with the point-of-sale hardware and software used by Merchant A 103.

As depicted in step Pay Fees 205, preferably Merchant A 103 pays required fees associated with participation in Receipt Card System 100. Optionally, Merchant A 103 may pay additional fees associated with advertising, coupons and rebate offers presented on Website 215.

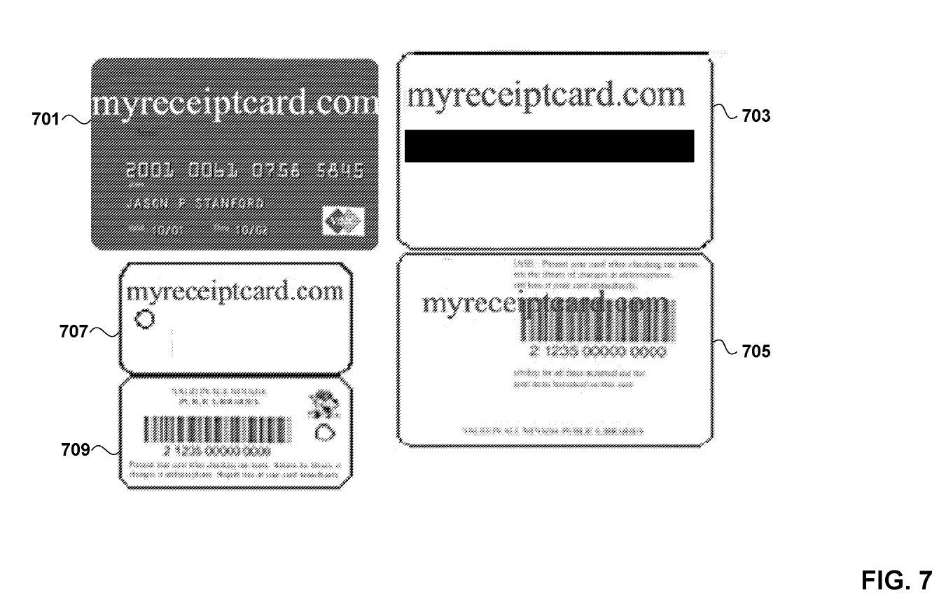

Preferably, in step Sign Up for Receipt Card 208 Manager 200 offers services of Receipt Card System 100 to Consumer 101 through various advertising means (at least herein embodying offering electronic accumulation of such line-item data to such at least one consumer). Preferably, Consumer 101 may sign up for participation in Receipt Card System 100 by either completing an online profile through Website 215 or by using forms available at checkout at Merchant A 103 or by completing and submitting forms provided in conjunction with a product. If Consumer 101 signs up at Merchant A 103 preferably Consumer 101 will complete necessary profile information by accessing Website 215 using a temporary login and password. Preferably, in either case, Consumer 101 receives a unique identification number and at least one Receipt Card 531 (see FIG. 7 for examples of the various card forms which may be used) (at least herein embodying assigning at least one unique consumer identifier to such at least one consumer; at least herein embodying providing at least one consumer identification card to such at least one consumer; and at least herein embodying such at least one consumer identification card comprises such at least one unique consumer identifier). Preferably, Consumer 101 pays a fee to sign up and participate in Receipt Card System 100 when signing up through Website 215 or at checkout at Merchant A 103 (at least herein embodying receiving at least one payment from such at least one consumer). If Consumer 101 signs up at checkout, Merchant A 103 optionally collects the fee and sends it, less a set percentage, to Manager 200. Upon reading the teachings of this specification, those with ordinary skill in the art will now understand that, under appropriate circumstances, considering issues such as competition, changing market conditions, etc., other fee arrangements, such as, for example, offering services of the receipt card system at no charge to consumers, etc., may suffice.

Preferably, after signing up Consumer 101 may use the Receipt Card 531 when making purchases at Merchant A 103, as shown in step Make Purchases Using Receipt Card 209 (at least herein embodying permitting use of such at least one consumer identification card for relating such line item data to such at least one consumer). Alternatively, if Receipt Card 531 is not available, Consumer 101 may manually enter an alternate identification (such as telephone number) as a means for linking the purchase with Consumer 101 (at least herein embodying permitting use of such at least one unique consumer identifier for relating such line item data to such at least one consumer). Use of Receipt Card 531 (or alternate identification), in conjunction with Receipt Card POS 533, at Merchant A 103 at the time of purchase preferably results in the line-item detail of the purchase transaction being transferred electronically to Receipts Database System 207 as depicted by step Provide Purchase Data 213 (at least herein embodying receiving line-item data relating to at least one plurality of transactions between at least one consumer of at least one plurality of consumers and at least one plurality of sellers; and at least herein embodying electronically receiving such line-item data from such at least one seller). Preferably, once the purchase transaction line-item detail has been transferred to Receipts Database System 207 Consumer 101 may review the line-item detail by logging into Website 215, as shown in step Access Website 133.

According to a preferred embodiment of the present invention, in step Manage Receipts Database System 202 Manager 200 preferably performs all necessary system management tasks including, for example, setting up new merchants, removing merchants who have resigned, removing history after consumers who are no longer members as well as other routine database management tasks necessary to ensure smooth operation of the Receipts Database System 207 and Website 215.

Preferably, in step Provide Rebate/Coupon Data 216 Merchant A 103 may elect to present rebate and coupon offers to Consumer 101 when logged onto Website 215. Preferably, the rebate and coupon offers may optionally be associated products of Merchant A 103 so that when Consumer 101 is viewing line-item detail rebates and coupons for the product, similar, or related products are presented to Consumer 101. Preferably, coupons and rebates presented will be appropriate for a geographic area associated with Consumer 101.

Preferably, in step Provide Website Advertising 217 Merchant A 103 may elect to present advertisements to Consumer 101 when logged onto Website 215 (at least herein embodying offering to present seller advertising to such at least one consumer on behalf of such at least one seller). Preferably, the advertisements may optionally be associated products of Merchant A 103 so that advertisements for the product, similar, or related products are presented to Consumer 101 when Consumer 101 is viewing line-item detail (at least herein embodying such seller advertising is related to such line-item data related to such at least one consumer). Preferably, advertisements presented will be appropriate for a geographic area associated with Consumer 101.

According to a preferred embodiment of the present invention, Manager 200 provides summary purchase data to Merchant A 103 as shown in step Receive Summary Analyses 219. Preferably, the summary purchase data will be summary in nature and will not include any personally identifying information related to Consumer 101. Upon reading the teachings of this specification, those with ordinary skill in the art will now understand that, under appropriate circumstances, considering issues such as privacy requirements and limitations, etc., other reporting arrangements, such as, for example, providing card usage activity reports only, etc., may suffice.

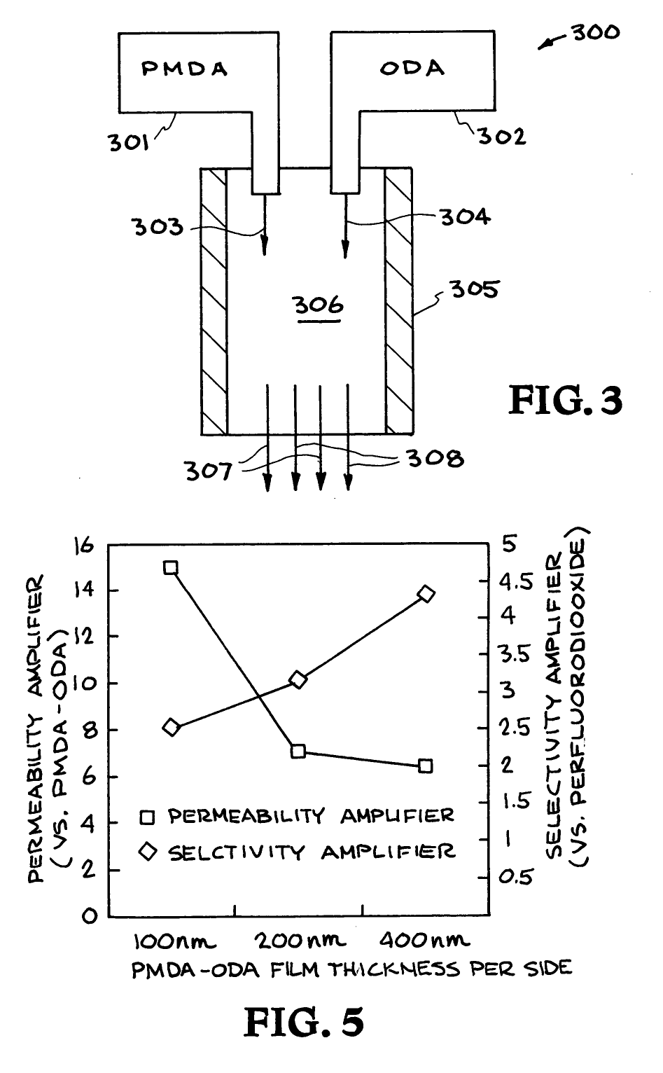

Referring to FIG. 3, a simplified functional diagrammatical overview of the Manufacturer Processes 300 of the receipt card system according to a preferred embodiment of the present invention, in step Sign Advertising Agreement 303, Manager 200 preferably signs an advertising agreement with Manufacturer 301 (representative of all manufacturers and distributors wishing to advertise, or offer rebates or coupons to Consumer 101) (at least herein embodying offering to present manufacturer advertising to such at least one consumer on behalf of at least one manufacturer). Manager 200 preferably commits to permit Manufacturer 301 to assign Manufacturer 301 a unique identifier, to permit advertising, which may be related to line-item data, to be displayed on Website 215 and to provide Manufacturer 301 summary reports related to transaction activity for products offered by Manufacturer 301 (at least herein embodying assigning at least one unique manufacturer identifier on behalf of such at least one manufacturer; and at least embodying herein providing summarized line-item data reports on behalf of such at least one manufacturer). Preferably, Manufacturer 301 may also provide offer coupon and rebate information, which may be related to line-item data, and displayed on Website 215. Preferably, Manufacturer 301 may also provide offer warranty information to be related to line-item detail and displayed on Website 215. Further, Manufacturer 301 preferably agrees to pay required fees associated with services provided by Manager 200 (at least herein embodying receiving at least one payment on behalf of such at least one manufacturer).

Preferably, in step Provide Product Advertising 305 Manufacturer 301 may elect to provide advertisements for presentation to Consumer 101 when Consumer 101 is logged onto Website 215. Preferably, the advertisements are associated products of Manufacturer 301 so that advertisements for the product, similar, or related products are presented to Consumer 101 when Consumer 101 is viewing line-item detail (at least herein embodying manufacturer advertising is related to such line-item data related to such at least one consumer). Preferably, product advertisements presented will be appropriate for merchants in a geographic area associated with Consumer 101.

Preferably, in step Provide Rebate/Coupon/Warranties 307 Manufacturer 301 may elect to provide rebate and coupon offers and or warranty offers for presentation to Consumer 101 when logged onto Website 215. Preferably, the rebate and coupon offers may optionally be associated products of Manufacturer 301 so that when Consumer 101 is viewing line-item detail rebates and coupons for the product, or similar related products, are presented to Consumer 101. Preferably, coupons and rebates presented will be appropriate for a geographic area associated with Consumer 101. Preferably warranties presented will be related to line-item detail related to Consumer 101 (at least herein embodying electronically receiving at least one warranty-based offer related to such line-item data).

As depicted in step Pay Manufacturer Fees 309, preferably Manufacturer 301 pays required fees associated with advertising on Website 215 of Receipt Card System 100. Optionally, Manufacturer 301 may pay additional fees associated with coupons and rebate offers presented on Website 215.

According to a preferred embodiment of the present invention, Manager 200 provides summary data to Manufacturer 301 as shown in step Receive Summary Analyses 311. Preferably, the data will be summary in nature and will not include any personally identifying information related to Consumer 101. Upon reading the teachings of this specification, those with ordinary skill in the art will now understand that, under appropriate circumstances, considering issues such as privacy requirements and limitations, etc., other reporting arrangements, such as, for example, providing product purchase activity, etc., may suffice.

Referring to FIG. 4, a summary schematic of the primary functions available to a consumer through Website 215 according to a preferred embodiment of the present invention, function Manual Input 401 preferably provides a variety of input functions for Consumer 101 including: manual input, and accumulation in Receipts Database 113, of receipt line-item detail for a purchase transaction completed at a merchant that is not participating in Receipt Card System 100; manual input of receipt line-item detail for Merchant A 103 when Receipt Card 531 or unique identifier could not be used; modify or delete manually entered receipt line-item detail or an entire receipt (at least herein embodying receiving line-item data relating to such at least one transaction from such at least one consumer; and at least herein embodying electronically accumulating, in such at least one transaction database, such inputted line-item data relating to such at least one transaction). Preferably, automatically downloaded receipts can not be changed by Consumer 101.

Preferably, Consumer 101 may use function Print Receipt 403 to print or re-print any receipt contained in the Receipts Database System 207 in its entirety (at least herein embodying such line-item data is substantially sufficient to replicate such at least one transaction). Additionally, preferably Consumer 101 may elect a gift receipt format (all receipt information is included except the item price) to print or re-print any receipt. Preferably receipts downloaded by Merchant A 103 and reprinted as a full receipt or as a gift receipt would be acceptable as proof of purchase when Consumer 101 wishes to return a product. Products returned by Consumer 101 to Merchant A 103 are preferably recorded in the same manner as the original transaction by Receipt Card POS 533 and downloaded to Receipt Card System 100 which then preferably matches the return receipt to the original receipt and notes the returned item on the original receipt to prevent re-use of a receipt to return the same product.

Preferably, function Coupon/Rebate Forms 405 encompasses means for identifying and printing coupons, rebates and warranty information of importance to Consumer 101. Particularly, preferably, Consumer 101 may select a hypertext link to Merchant A 103 to view all coupon and rebate offers, and any related restrictions or quantity requirements, available from Merchant A 103 or from Manufacturer 301 whose products are sold by Merchant A 103 (at least herein embodying such at least one coupon-based offer is provided on behalf of such at least one seller; at least embodying herein such at least one coupon-based offer is provided by on behalf of such least one manufacturer; at least embodying herein such at least one rebate-based offer is provided on behalf of such at least one seller; and at least embodying herein such at least one rebate-based offer is provided on behalf of such at least one seller). Further, Consumer 101 may select a hypertext link for Manufacturer 301 to view all coupon and rebate offers and any related restrictions or quantity requirements. Additionally, preferably, Consumer 101 may select a hypertext link to Manufacturer 301 to view all warranties (including terms, requirements and expiration dates) related to purchase history of Consumer 101. Preferably Consumer 101 may also select a product to determine if any coupon, rebate offers, or warranties are available. Receipt Card System 100 may also suggest coupon or rebate offers for the same or similar products based on purchase history of Consumer 101 (at least herein embodying providing at least one coupon-based offer to such at least one consumer; at least embodying herein wherein in such coupon-based offer is related to such line-item data related to such at least one consumer; at least embodying herein offering at least one rebate-based offer to such at least one consumer; at least herein embodying electronically notifying such at least one consumer of such at least one warranty-based offer). Preferably, Consumer 101 may select a coupon or rebate offer and print the coupon, rebate offer or warranty information for presentation to Merchant A 103 or Manufacturer 301 (at least herein embodying permitting printing, by such at least one consumer, of such at least one coupon-based offer; and at least embodying herein permitting printing, by such at least one consumer, of at least one rebate-based offer form). Preferably, Consumer 101 may also be notified by email of available rebates, coupons, or warranty expirations based on their purchase history (at least herein embodying electronically notifying such at least one consumer of such at least one coupon-based offer relating to such at least one transaction; and at least embodying herein electronically notifying such at least one consumer of such at least one rebate-based offer relating to such line-item data related to such at least one consumer).

According to a preferred embodiment of the present invention, function Print Reports 406 preferably permits Consumer 101 to select a report, set the desired selection criteria, set the desired sort sequence and print both a tabular or graphical analysis of the selected and sorted line-item detail (at least herein embodying permitting electronic summarization of such line-item data; and at least embodying herein permitting at least one graphical presentation of such summarized such line item data). Preferably, selection criteria comprise date, date range, product, merchant, merchant type and product type (at least herein embodying such summarization of line-item data is by such at least one seller identifier; at least embodying herein summarization of line-item data is by such at least one manufacturer identifier; at least embodying herein summarization of line-item data is by such at least one manufacturer identifier). Preferably, sort order comprises at least date, date range, product, merchant, merchant type and product type (at least herein embodying comprising the step of providing line-item data reports to such at least one consumer).

Preferably, function Submit Rebate Online 407 permits Consumer 101 to complete a selected rebate form and electronically submit it, along with an electronic copy of the receipt to the offeror, Merchant A 103 or Manufacturer 301 (at least embodying herein permitting completion, by such at least one consumer, of at least one rebate-based offer form relating to such at least one rebate-based offer; and at least embodying herein permitting electronic submission, by such at least one consumer, of completed such at least one rebate-based offer form to at least one rebate-based offer provider). Alternatively, Consumer 101 may be provided a hypertext link to a website of Merchant A 103 or Manufacturer 301 which permits completion and electronic submission of a rebate form.

Function Rebate/Warranty Reminder 408 preferably matches line-item detail to available rebate offers and warranties provided by Merchant A 103 and Manufacturer 301 and generates at least one pop-up message to Consumer 101 at login, or generates at least one email reminder to Consumer 101, regarding rebate requirements and expirations or warranty requirements and expirations (at least herein embodying electronically providing to such at least one consumer at least one expiration reminder notice related to such at least one rebate-based offer; and at least herein embodying electronically providing to such at least one consumer at least one second expiration reminder notice related to such at least one warranty-based offer).

Function Query 409 preferably provides the capability for Consumer 101 to search line-item detail across members of Receipt Card System 100 to identify best prices paid. Preferably, no personal information of other members associated with the line-item detail is revealed to Consumer 101. Preferably, Consumer 101 may use function Query 409 to find the lowest price recently paid for a product and the merchant from which it was purchased (at least herein embodying comprising the step of permitting identification, by such at least one consumer, of such at least one seller offering such at least one product least expensively). Preferably, Consumer 101 may also query for other savings tips based on analysis of the line-item detail accumulated across many members.

According to a preferred embodiment of the present invention function Transfer Data 411 permits Consumer 101 to periodically transfer line-item detail to a personal computer, or similar computer system where a selected a personal financial manager, such as Intuit Quicken or Microsoft Money, or a small business accounting system, such as QuickBooks from Intuit, Inc. is installed (at least herein embodying permitting electronic transfer of such accumulated line-item data to at least one computer program system controlled by such at least one consumer). Preferably, function Transfer Data 411 also permits Consumer 101 to receive SMS (or similar) electronic text messages containing transaction line-item detail sent to any digital wireless device, such as Digital Mobile Phone 221.

Preferably, function Sign Up/Manage Profile 413 permits Consumer 101 to initially sign up and pay membership fees. Preferably, it also permits Consumer 101 to revise their profile information such as name and address, reset their password, provide updated credit card information and set their preferences regarding accumulation of line-item detail and default reporting, transmission of text messages (SMS messages) to Digital Mobile Phone 221, etc.

Referring to FIG. 5, an overall schematic depicting the transaction flows and relationships between the primary components and entities of the receipt card system according to the preferred embodiment of the present invention, transaction and data flow begins when Consumer 101 makes a purchase at Merchant A 103 and uses Receipt Card 531 as depicted by Purchase Transaction 121. Preferably, Receipt Card POS 533 (which preferably includes point-of-sale hardware and software for accepting Receipt Card 531 and necessary hardware and or software to interface Receipt Card POS 533 with Merchant POS 525) permits Consumer 101 to “swipe” Receipt Card 531 on the credit card reader, or to “swipe” a combination credit card containing consumer's receipt card identification number, or to key enter their receipt card identification number. Upon reading the teachings of this specification, those with ordinary skill in the art will now understand that, under appropriate circumstances, considering issues such as technological requirements, capabilities of various merchant point-of-sale system, etc., other arrangements for capturing a consumer's receipt card identification number, such as, for example, use of bar codes, etc., may suffice. Preferably, presentation by Consumer 101 of consumer's receipt card identification number causes Receipt Card POS 533, working in concert with Merchant POS 525, to associate the transaction line-item detail with Consumer 101 and to store it for later forwarding to Receipt Database System 207. As depicted, stored line-item detail data is electronically transferred by communication between Merchant POS 525 and Data Collection Module 509 of Receipt Card Database System 207 in process Transaction Data Transfer 123. Preferably, Data Collection Module 509 communicates with each Merchant POS 525 operated by Merchant A 103. Preferably, communication and transfer of stored line-item detail may be accomplished in any one of a variety of well-known methods. Preferably, Data Collection Module 509 manages transfer and validation of line-item detail and then adds the line-item detail to Receipts Database 113 (at least herein embodying electronically accumulating, in at least one transaction database, such line-item data relating to such at least one plurality of transactions on behalf of such at least one consumer). Preferably, Consumer 101 uses Consumer PC 454 to access Website 215 via Internet 543 to use the functionality described with reference to FIG. 4 to access the stored line-item detail. User interface examples are presented in FIG. 8, FIG. 9 and FIG. 10. Additionally, preferably Consumer 101 may use Digital Mobile Phone 221 (or similar wireless device, such as a personal digital assistant) that is capable of accessing Website 215 via Internet 543 to use the functionality described with reference to FIG. 4 to access the stored line-item detail. Optionally, Consumer 101 may elect to receive SMS (or similar) text messages containing transaction line-item detail sent to a wireless device, such as Digital Mobile Phone 221 from Receipt Database System 207. Upon reading the teachings of this specification, those with ordinary skill in the art will now understand that, under appropriate circumstances, considering such issues as advances in technology, consumer preferences, user location, etc., other personal digital assistants capable of wireless connection to the Internet, such as BlackBerry® offered by Research in Motion Limited, Treo™ offered by Palm, Inc., etc., may suffice. Preferably, Consumer 101 may request automatic transmission of SMS (or similar) text messages containing transaction line-item detail sent to a wireless device, such as Digital Mobile Phone 221 by Receipt Database System 207 for purchases made at un-attended sales locations of Merchant A 103.

Preferably, Manager 200 utilizes System Management Module 513 to perform required management of Receipt Database System 207. Management of Receipt Database System 207 includes, for example, setting up new merchants, removing merchants who have resigned, removing history for consumers who are no longer members as well as other routine database management tasks necessary to ensure smooth operation of the Receipts Database System 207 and Website 215

According to a first alternate preferred embodiment receipt card identification information (including receipt card identification number) may be combined with a credit card to eliminate the need for to carry a separate Receipt Card 531 Consumer 101. Preferably, presentation by Consumer 101 of a credit card which includes receipt card identification information causes Receipt Card POS 533, working in concert with Merchant POS 525, to associate the transaction line-item detail with Consumer 101 and to store it for later forwarding to Receipt Database System 207 (at least herein embodying permitting use of such at least one combined credit card for relating such line item data to such at least one consumer).

According to a second alternate preferred embodiment receipt card identification information (including receipt card identification number) may be combined with a customer loyalty card to eliminate the need to carry a separate Receipt Card 531 for Consumer 101. Preferably, presentation by Consumer 101 of a customer loyalty card which includes receipt card identification information causes Receipt Card POS 533, working in concert with Merchant POS 525, to associate the transaction line-item detail with Consumer 101 and to store it for later forwarding to Receipt Database System 207 (at least herein embodying permitting use of such at least one combined loyalty card for relating such line item data to such at least one consumer).

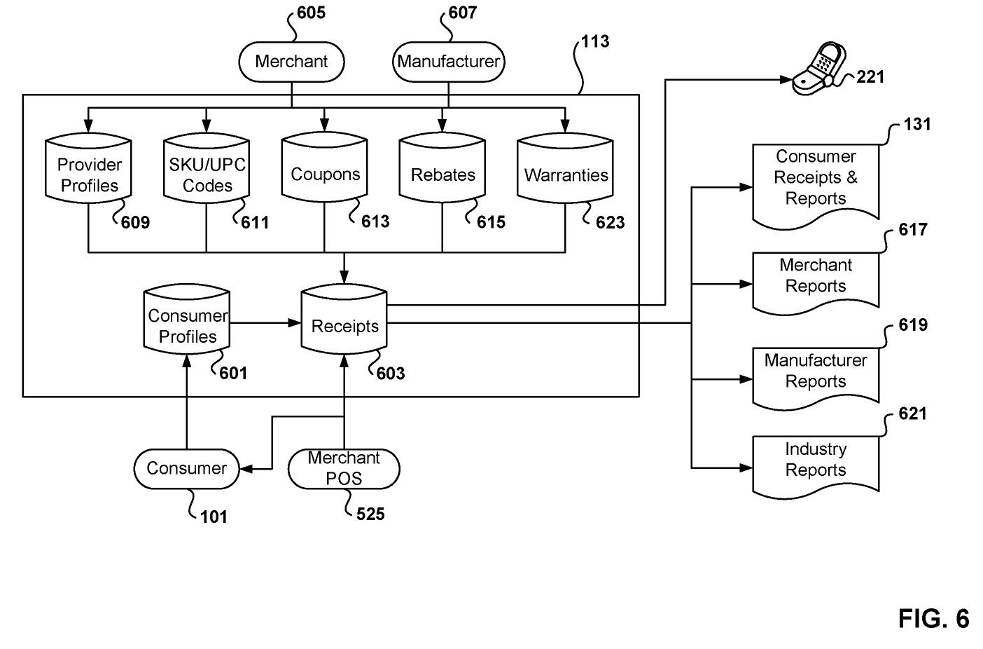

Referring to FIG. 6, a schematic of the data flows and primary databases utilized by Receipt Database System 207 according to a preferred embodiment of the present invention, Receipts Database 113 preferably comprises a variety of specialized databases to store line-item detail for consumers and to manage and control Receipt Database System 207. Preferably, Receipts 603 contains line-item detail for all transactions provided by Merchant POS 525 operated by Merchant A 103 for Consumer 101. Preferably, line-item detail data comprises:

transaction identifier;

transaction date;

merchant identifier;

product identifier, such as SKU or UPC;

selling price for each product;

amount tendered;

payment method;

sales tax amount;

discount amount; and

discount identifier.

Preferably, access by Consumer 101 to Receipts 603 is controlled by Consumer Profiles 601 which contains profile and access permissions for Consumer 101 as well as billing and payment information.

Preferably, Provider Profiles 609 contains company profiles, such as company name and address, type of company, company identifier, etc. and access permissions for both Merchant A 103 and Manufacturer 301. Provider Profiles 609 may also contain billing and payment information as well related to Merchant A 103 and/or Manufacturer 301.

Preferably, Merchant A 103 and/or Manufacturer 301 will provide content for SKU/UPC Codes 611, Coupons 613, Rebates 615 and Warranties 623. Preferably, SKU/UPC Codes 611 contains stock keeping unit codes (SKU) and/or universal product coding codes (UPC) and related product information such as name, size, product type, etc. to permit de-coding line-item detail for viewing by Consumer 101.

Preferably, Coupons 613 contains coupon information related to specific products. Typical information included is coupon expiration date, SKU/UPC of product, discount amount, other requirements or limitations, and a coupon image or representation suitable for printing by Consumer 101.

Preferably, Rebates 615 contains rebate information related to specific products. Typical information included is rebate expiration date, SKU/UPC of product, rebate amount, other requirements or limitations, and a rebate form image or representation suitable for printing by Consumer 101. Rebate information may also include hypertext links to rebate submission websites to permit online submission of completed rebate forms.

Preferably, Warranties 623 contains warranty information related to specific products. Typical information included is warranty expiration date, SKU/UPC of product, warranty limitations, other requirements, and a warranty form image or representation suitable for printing by Consumer 101. Warranty information may also include hypertext links to warranty claim submission websites to permit online submission of completed warranty claim forms.

Preferably, each of the specialized databases is used to provide Consumer Receipts and Reports 131 to Consumer 101, Merchant Reports 617 to Merchant A 103, Manufacturer Reports 619 to Manufacturer 301 and Industry Reports 621 for a variety of uses including marketing by Manager 200.

Although applicant has described applicant's preferred embodiments of this invention, it will be understood that the broadest scope of this invention includes modifications such as diverse shapes, sizes, and materials. Such scope is limited only by the below claims as read in connection with the above specification.

Further, many other advantages of applicant's invention will be apparent to those skilled in the art from the above descriptions and the below claims.

What is claimed is:

1) A system, relating to centralized consumer assistance, comprising the steps of:
a) receiving line-item data relating to at least one plurality of transactions between at least one consumer of at least one plurality of consumers and at least one plurality of sellers;
b) electronically accumulating, in at least one transaction database, such line-item data relating to such at least one plurality of transactions on behalf of such at least one consumer; and
c) permitting such at least one consumer to view such line-item data relating to such at least one plurality of transactions.

2) The system according to claim 1 wherein the step of permitting such at least one consumer to view such line-item data comprises the step of using at least one Internet-based-web-site computer system.

3) The system according to claim 2 wherein the step, of receiving line-item data relating to at least one plurality of transactions between at least one consumer of at least one plurality of consumers and at least one plurality of sellers, comprises the step of electronically receiving such line-item data from such at least one seller.

4) The system according to claim 3 further comprising the steps of:
a) offering electronic accumulation of such line-item data to such at least one consumer;
b) assigning at least one unique consumer identifier to such at least one consumer;
c) providing at least one consumer identification card to such at least one consumer;
d) wherein such at least one consumer identification card comprises such at least one unique consumer identifier;
e) permitting use of such at least one unique consumer identifier to relate such line item data to such at least one consumer; and
f) permitting use of such at least one consumer identification card to relate such line item data to such at least one consumer.

5) The system according to claim 4 further comprising the step of receiving at least one payment from such at least one consumer relating to such accumulating.

6) The system according to claim 4 further comprising the step of permitting electronic transfer of such accumulated line-item data to at least one computer program system controlled by such at least one consumer.

7) The system according to claim 4 further comprising the steps of:
a) permitting combining such at least one unique consumer identifier with at least one credit card provided to such at least one consumer by at least one credit card issuer;
b) permitting use of such at least one combined credit card for relating such line item data to such at least one consumer; and
c) electronically receiving such related line-item data from such at least one credit card issuer.

8) The system according to claim 4 further comprising the steps of:
a) permitting combining of such at least one unique consumer identifier with at least one loyalty card provided to such at least one consumer by at least one loyalty card issuer;
b) permitting use of such at least one combined loyalty card for relating such line item data to such at least one consumer; and
c) electronically receiving such related line-item data from such at least one loyalty card issuer.

9) The system according to claim 4 further comprising the steps of:
a) electronically receiving at least one coupon-based offer;
b) relating such at least one coupon-based offer to such line-item date;
c) electronically notifying such at least one consumer of such at least one coupon-based offer related to such line-item data; and
d) permitting printing, by such at least one consumer, of such at least one coupon-based offer.

10) The system according to claim 4 further comprising the steps of:
a) electronically receiving at least one rebate-based offer;
b) relating such at least one rebate-based offer to such line-item date;
c) offering at least one rebate-based offer to such at least one consumer;
d) electronically notifying such at least one consumer of such at least one rebate-based offer relating to such line-item data;
e) permitting completion, by such at least one consumer, of at least one rebate-based offer form relating to such at least one rebate-based offer;
f) permitting printing, by such at least one consumer, of at least one rebate-based offer form;
g) permitting electronic submission, by such at least one consumer, of completed such at least one rebate-based offer form to at least one rebate-based offer provider; and
h) electronically providing to such at least one consumer at least one first expiration reminder notice related to such at least one rebate-based offer.

11) The system according to claim 4 further comprising the steps of:
a) electronically receiving at least one warranty-based offer related to such line-item data;
b) electronically notifying such at least one consumer of such at least one warranty-based offer; and
c) electronically providing to such at least one consumer at least one second expiration reminder notice related to such at least one warranty-based offer.

12) The system according to claim 3 further comprising the steps of:
a) offering assistance with such electronic line-item data accumulation to such at least one seller;
b) assigning at least one unique seller identifier to such at least one seller;
c) receiving at least one payment on behalf of such at least one seller; and
d) providing at least one summarized line-item data report to such at least one seller.

13) The system according to claim 3 further comprising the steps of:
a) offering to present advertising to such at least one consumer on behalf of at least one advertiser;
b) assigning at least one unique advertiser identifier on behalf of such at least one advertiser;
c) receiving at least one payment on behalf of such at least one advertiser; and
d) providing at least one summarized line-item data report on behalf of such at least one advertiser.

14) The system according to claim 3 wherein such line-item data is substantially sufficient to replicate such at least one transaction.

15) The system according to claim 14 comprising the step of electronically transmitting such replicated at least one transaction using electronic messaging to at least one electronic device, capable of receiving such electronic messages, controlled by such at least one consumer.

16) The system according to claim 3 further comprises the step of providing at least one line-item data report to such at least one consumer.

17) The system according to claim 3 further comprising the step of permitting identification, by such at least one consumer, of such at least one seller offering such at least one product least expensively.

18) A computer program system for an Internet computer web site system, relating to centralized consumer assistance, comprising the steps of:
a) electronically receiving line-item data relating to at least one plurality of transactions between at least one consumer of at least one plurality of consumers and at least one seller of at least one plurality of sellers;
b) storing, in at least one transaction database, such line-item data relating to such at least one plurality of transactions; and
c) permitting viewing by such at least one consumer of such line-item data relating to such at least one plurality of transactions.

19) The computer program system according to claim 18 further comprising the steps of:
a) permitting input by such at least one consumer of at least one consumer profile;
b) assigning at least one unique consumer identifier to such at least one consumer;
c) storing such at least one consumer profile in at least one consumer database;
d) encoding at least one consumer identification card with such at least one unique consumer identifier; and
e) associating such line-item data with such at least one unique consumer identifier.

20) The computer program system according to claim 19 further comprising the steps of:
a) permitting input by such at least one consumer of such line-item data relating to such at least one transaction; and
b) storing, in such at least one transaction database, such inputted line-item data.

21) The computer program system according to claim 19 further comprising the step of permitting electronic transfer of such stored line-item data to at least one computer program system controlled by such at least one consumer.

22) The computer program system according to claim 18 further comprising the steps of:
a) electronically receiving at least one seller profile on behalf of such at least one seller;
b) wherein such at least one seller profile comprises at least one seller identifier; and
c) storing such at least one seller profile in at least one seller database.

23) The computer program system according to claim 22 further comprising the steps of:
a) electronically receiving at least one manufacturer profile on behalf of at least one manufacturer;
b) wherein such at least one seller profile comprises at least one manufacturer identifier; and
c) storing such at least one manufacturer profile in at least one manufacturer database.

24) The computer program system according to claim 23 further comprising a) electronically receiving at least one warranty-based offer related to such line-item data related to such at least one consumer;
b) electronically notifying such at least one consumer of expiration of at least one warranty-based offer; and
c) electronically providing to such at least one consumer at least one expiration reminder notice related to such at least one warranty-based offer.

25) The computer program system according to claim 23 further comprising the steps of:
a) electronically providing such summarized line-item data on behalf of such at least one seller; and
b) electronically providing such summarized line-item data on behalf of such at least one manufacturer.

26) The computer program system according to claim 23 further comprising the step of permitting identification, by such at least one consumer, of such at least one seller offering such at least one product least expensively.

27) The computer program system according to claim 18 further comprising the steps of:
a) electronically receiving at least one advertisement;
b) storing such at least one advertisement in at least one advertisement database; and
c) presenting such stored such at least one advertisement to such at least one consumer.

28) The computer program system according to claim 27 further comprising the step of relating such at least one advertisement to such line-item data related to such at least one consumer.

29) The computer program system according to claim 18 further comprising the steps of:
a) electronically receiving at least one coupon-based offer;
b) providing at least one coupon-based offer to such at least one consumer;
c) electronically notifying such at least one consumer of such at least one coupon-based offer;
d) permitting printing, by such at least one consumer, of such at least one coupon-based offer form relating to such at least one coupon-based offer; and
e) relating such at least one coupon-based offer to such line-item data related to such at least one consumer.

30) The computer program system according to claim 18 further comprising the steps of:
a) electronically receiving at least one rebate-based offer;
b) providing at least one rebate-based offer to such at least one consumer;
c) electronically notifying such at least one consumer of such at least one rebate-based offer related to such line-item data related to such at least one consumer; and
d) permitting printing, by such at least one consumer, of such at least one rebate-based offer form relating to such at least one rebate-based offer.

31) The computer program system according to claim 18 wherein such line-item data is substantially sufficient to replicate such at least one transaction.

32) The system according to claim 31 further comprising the step of transmitting such replicated transaction using electronic messaging to at least one electronic device, capable of receiving such electronic messages, controlled by such at least one consumer.

33) The computer program system according to claim 18 further comprising the step of electronically providing line-item data reports to such at least one consumer.

34) A system for an Internet computer web site system, relating to centralized consumer assistance, comprising:
a) at least one computer processor structured and arranged to receive line-item data relating to at least one plurality of transactions between at least one consumer of at least one plurality of consumers and at least one seller of at least one plurality of sellers;
b) at least one computer database structured and arranged to store, in at least one transaction database, such line-item data relating to such at least one plurality of transactions;
c) wherein such line-item data is substantially sufficient to replicate such at least one transaction;
d) at least one computer interface structured and arranged to permit viewing by such at least one consumer of such line-item data relating to such at least one plurality of transactions;
e) at least one computer processor structured and arranged to receive at least one advertisement;
f) at least one computer database structured and arranged to store such at least one advertisement in at least one advertisement database;
g) at least one computer interface structured and arranged to present such stored such at least one advertisement to such at least one consumer;
h) at least one computer processor structured and arranged to relate such at least one advertisement to such line-item data related to such at least one consumer;
i) at least one computer processor structured and arranged to receive at least one coupon-based offer;
j) at least one computer processor structured and arranged to provide at least one coupon-based offer to such at least one consumer;
k) at least one computer processor structured and arranged to notify such at least one consumer of such at least one coupon-based offer;
l) at least one computer interface structured and arranged to permit printing, by such at least one consumer, of such at least one coupon-based offer form relating to such at least one coupon-based offer;
m) at least one computer processor structured and arranged to transmit such at least one transaction using electronic messaging to at least one electronic device, capable of receiving such electronic messages, controlled by such at least one consumer;
n) at least one computer processor structured and arranged to provide at least one line-item data report to such at least one consumer;
o) at least one computer processor structured and arranged to identify, by such at least one consumer, such at least one seller offering such at least one product least expensively;
p) at least one computer processor structured and arranged to receive at least one rebate-based offer;
q) at least one computer processor structured and arranged to relate such at least one rebate-based offer to such line-item date;
r) at least one computer processor structured and arranged to offer at least one rebate-based offer to such at least one consumer;
s) at least one computer processor structured and arranged to notify such at least one consumer of such at least one rebate-based offer relating to such line-item data;
t) at least one computer processor structured and arranged to permit completion, by such at least one consumer, of at least one rebate-based offer form relating to such at least one rebate-based offer;
u) at least one computer processor structured and arranged to permit printing, by such at least one consumer, of at least one rebate-based offer form;
v) at least one computer processor structured and arranged to permit electronic submission, by such at least one consumer, of completed such at least one rebate-based offer form to at least one rebate-based offer provider;
w) at least one computer processor structured and arranged to provide to such at least one consumer at least one first expiration reminder notice related to such at least one rebate-based offer;
x) at least one computer processor structured and arranged to receive at least one warranty-based offer related to such line-item data related to such at least one consumer;
y) at least one computer processor structured and arranged to notify such at least one consumer of at least one warranty-based offer; and
z) at least one computer processor structured and arranged to provide to such at least one consumer at least one second expiration reminder notice related to such at least one warranty-based offer.
